(19) United States
(12) Patent Application Publication
(10) Pub. No.: US 2014/0269417 A1
(43) Pub. Date: Sep. 18, 2014

(54) Configuring Relay Nodes

(71) Applicant: Nokia Siemens Networks Oy, Espoo (FI)

(72) Inventors: Ling Yu, Oulu (FI); Vinh Van Phan, Oulu (FI); Kari Veikko Horneman, Oulu (FI)

(73) Assignee: Nokia Siemens Networks Oy, Espoo (FI)

(21) Appl. No.: 13/994,156

(22) PCT Filed: Dec. 15, 2010
(86) PCT No.: PCT/EP10/69775

§ 371 Date: Jun. 14, 2013

(51) Int. Cl. H04L 12/24

(52) U.S. Cl. CPC H04L 41/0803
USPC 370/254

(57) ABSTRACT

In accordance with the exemplary embodiments there is at least a method and apparatus to perform operations of: configuring a relay node group including sending to a network access node determined information associated with the relay node group. Configuration information associated with the relay node group is received from the network access node. The configuration information is determined based on the determined information associated with the relay node group. The configuration information is distributed to one or more relay nodes of the relay node group and is for configuring one or more relay nodes of the relay node group to communicate with the network access node.

The invention relates to configuring a group of relay nodes for relaying information to a mobile communication device in a communication system.

A communication system can be seen as a facility that enables communication sessions between two or more entities such as mobile communication devices and/or other stations associated with the communication system. A communication system and a compatible communication device typically operate in accordance with a given standard or specification which sets out what the various entities associated with the system are permitted to do and how that should be achieved. For example, the manner how the communication device can access the communication system and how communications shall be implemented between communicating devices, the elements of the communication network and/or other communication devices is typically defined.

In a wireless communication system at least a part of communications between at least two stations occurs over a wireless link. Examples of wireless systems include public land mobile networks (PLMN), satellite based communication systems and different wireless local networks, for example wireless local area networks (WLAN). In wireless systems an access node is provided by a base station. The radio coverage area of a base station is known as a cell, and therefore the wireless systems are often referred to as cellular systems. In some systems a base station access node is called Node B.

A user can access the communication system by means of an appropriate communication device. A communication device of a user is often referred to as user equipment (UE). A communication device is provided with an appropriate signal receiving and transmitting arrangement for enabling communications with other parties. A communication device may be arranged to communicate, for example, data for carrying communications such as voice, electronic mail (email), text message, multi-media, for enabling internet access and so on. Users may thus be offered and provided numerous services via their communication devices. The communication connection can be provided by means of one or more data bearers.

In wireless systems a communication device provides a transceiver station that can communicate with the access node and/or another communications device. A communication device or user equipment may also be considered as being a part of a communication system. In certain applications, for example in ad-hoc networks, the communication system can be based on use of a plurality of user equipment capable of communicating with each other.

A feature of wireless communication devices is that they offer mobility for the users thereof. A mobile communication device, or mobile device for short, may also be transferred, or handed over, from a base station to another and even between base stations belonging to different systems.

3^{rd} Generation Partnership Project (3GPP) is standardizing an architecture that is known as the long-term evolution (LTE) of the Universal Mobile Telecommunications System (UMTS) radio-access technology. The aim is to achieve, inter alia, reduced latency, higher user data rates, improved system capacity and coverage, and reduced cost for the operator. A further development of the LTE is referred to herein as LTE-Advanced. The LTE-Advanced aims to provide further enhanced services by means of even higher data rates and lower latency with reduced cost. The various development stages of the 3GPP LTE specifications are referred to as releases.

An aspect of controlling communications by mobile devices is known as mobility management. Mobility management provides control of active mobile devices moving within a certain area. In cellular systems mobility management is provided by a particular control entity. For example, in the LTE each access system is provided with a mobility management entity (MME). A MME control node is involved, inter alia, in idle mode user equipment tracking and paging procedures including retransmissions, in bearer activation/deactivation processes and in choosing a signalling gateway (SGW) for a user equipment at the initial attach and at time of intra-LTE handover involving core network (CN) node relocation.

Since the new spectrum bands for international mobile telecommunications (IMT) contain higher frequency bands and LTE-Advanced is aiming at a higher data rate, coverage of one base station may be limited due to the high propagation loss and limited energy per bit. Relaying has been proposed as a possibility to enlarge the coverage. Apart from this goal of coverage extension, introducing relay concepts may also help in the provision of high-bit-rate coverage in a high shadowing environment, reducing average radio-transmission power at the user equipment. This may provide improved battery life, enhanced cell capacity and effective throughput. Relaying may also reduce deployment costs of radio access networks (RAN).

Relaying can be provided by entities referred to as relay stations (RSs) or relay nodes (RNs). The relay nodes can be fixed or mobile, for example mounted to a high-speed train. In some systems the relay stations may be opportunistically available user equipment/mobile devices that are not owned by the network itself. Relay nodes may be organised into groups, for example into a co-operative cell group (CCG).

A start up procedure for each relay node under LTE-A in 3GPP Release 10 (3GPP TR 36.806, Relay architecture for E-UTRA) can be considered as a two stage process. In a first part the relay node attaches to the network via a legacy user equipment attach procedure to authenticate the user equipment function of the relay node and to establish basic connectivity. When connectivity is established, the second part of the start up procedure is for the network to authenticate a base station function of the relay node and sends configuration information to the relay node. After the relay node has received the configuration information the relay node goes into normal operation.

It is noted that the above discussed issues are not limited to any particular communication environment, but may occur in any appropriate communication system where muting of data transmissions may be provided.

Embodiments of the invention aim to address one or several of the above issues.

In accordance with an embodiment there is provided a method of configuring a relay node group comprising: sending to a network access node determined information associated with the relay node group; receiving from the network access node configuration information associated with the relay node group, the configuration information being determined based on the determined information associated with the relay node group; and distributing the configuration information for configuring one or more relay nodes of the relay node group to communicate with the network access node to one or more relay nodes of the relay node group.

In accordance with a more detailed embodiment, the method may comprise determining information associated with the relay node group from one or more relay nodes after the one or more relay nodes are activated and connections between the one or more relay nodes of the relay node group are established.

The method may further comprise selecting a relay node to communicate with the network access node and to send the determined information associated with the relay node group. Additionally the selected relay node may be selected on the basis of a random selection or on the basis of the relay node with the most direct connections to other relay nodes in the relay node group.

The configuration information can be determined based on predetermined relay node group subscription information. The predetermined relay node group subscription information may be one or more of the following: relay node group identifier, maximum number of relay nodes in the relay node group, one or more relay node identifiers, and network topology.

The relay node group can comprises a plurality of sub-groups of relay nodes and the configuration information is determined based on determined information associated one or more sub-groups of relay nodes. Optionally the sub-groups of relay nodes can be associated with different network operators.

The determined information associated with the relay node group may comprise one or more of the following: the number of activated relay nodes in the relay node group and the network topology.

The method can comprise activating other relay nodes of the relay node group after the one or more relay nodes have been configured with the configuration information.

The method may comprise distributing the configuration information to the other relay nodes.

Alternatively or additionally the receiving the configuration information can comprise sending reconfiguration information for reconfiguring one or more relay nodes of the relay node group in response to a change to the relay node group.

In accordance with another embodiment there is provided a method of configuring a relay node group comprising: receiving determined information associated with the relay node group from a relay node; determining configuration information associated with the relay node group for configuring one or more relay nodes of the relay node group to communicate with a network access node based on the determined information associated with the relay node group; and sending the configuration information to the relay node for distribution to the one or more relay nodes of the relay node group.

The method can comprise authenticating the one or more relay nodes for communication with the network access node on the basis of the determined information associated with the relay node group.

The determining the configuration information can comprise comparing predetermined relay node group subscription information with the determined information associated with the relay node group. The predetermined relay node group subscription information may be received from one or more relay nodes of the relay node group.

The sending the configuration information may comprise sending reconfiguration information for reconfiguring one or more relay nodes of the relay node group in response to a change to the relay node group.

In accordance with another embodiment there is provided a method of configuring a relay node group comprising: sending to a network access node information associated with the relay node group determined by a relay node; receiving from the network access node configuration information associated with the relay node group, the configuration information being determined based on the information associated with the relay node group, and configuring the relay node on the basis of the received configuration information to join the relay node group.

Additionally the method can comprise determining information associated with the relay node group. The determined information can comprise detected physical cell identification information.

In accordance with another embodiment there is provided a method of configuring a relay node group comprising: receiving from a relay node information associated with the relay node group determined by the relay node; determining configuration information of the relay node for configuring the relay node to join the relay node group based on the received information; sending the configuration information to the relay node.

The method can comprise sending reconfiguration information to one or more relay nodes of the relay node group for reconfiguring the relay node group in response to the relay node joining the relay node group. The network access node may be a donor enhanced node B.

In accordance with yet another embodiment there is provided an apparatus for configuring a relay node group comprising: means for sending to a network access node determined information associated with the relay node group; means for receiving from the network access node configuration information associated with the relay node group, the configuration information being determined based on the determined information associated with the relay node group; and means for distributing the configuration information for configuring one or more relay nodes of the relay node group to communicate with the network access node to one or more relay nodes of the relay node group.

In accordance with yet another embodiment there is provided an apparatus for configuring a relay node group comprising: means for receiving determined information associated with the relay node group from a relay node; means for determining configuration information associated with the relay node group for configuring one or more relay nodes of the relay node group to communicate with a network access node based on the determined information associated with the relay node group; and means for sending the configuration information to the relay node for distribution to the one or more relay nodes of the relay node group.

In accordance with yet another embodiment there is provided an apparatus for configuring a relay node group comprising: means for sending to a network access node information associated with the relay node group determined by a relay node; means for receiving from the network access node configuration information associated with the relay node group, the configuration information being determined based on the information associated with the relay node group, and means for configuring the relay node on the basis of the received configuration information to join the relay node group.

In accordance with yet another embodiment there is provided an apparatus for configuring a relay node group comprising: means for receiving from a relay node information associated with the relay node group determined by the relay node; means for determining configuration information of the relay node for configuring the relay node to join the relay node group based on the received information; and means for sending the configuration information to the relay node.

In accordance with yet another embodiment there is provided an apparatus comprising at least one processor and at least one memory including computer program code, the at least one memory and computer program code configured to with the at least one processor cause the apparatus at least to send to a network access node determined information associated with the relay node group; receive from the network access node configuration information associated with the relay node group, the configuration information being determined based on the determined information associated with the relay node group; and distribute the configuration information for configuring one or more relay nodes of the relay node group to communicate with the network access node to one or more relay nodes of the relay node group.

In accordance with yet another embodiment there is provided an apparatus comprising at least one processor and at least one memory including computer program code, the at least one memory and computer program code configured to with the at least one processor cause the apparatus at least to receive determined information associated with the relay node group from a relay node; determine configuration information associated with the relay node group for configuring one or more relay nodes of the relay node group to communicate with a network access node based on the determined information associated with the relay node group; and send the configuration information to the relay node for distribution to the one or more relay nodes of the relay node group.

In accordance with yet another embodiment there is provided an apparatus comprising at least one processor and at least one memory including computer program code, the at least one memory and computer program code configured to with the at least one processor cause the apparatus at least to send to a network access node information associated with the relay node group determined by a relay node; receive from the network access node configuration information associated with the relay node group, the configuration information being determined based on the information associated with the relay node group; and configure the relay node on the basis of the received configuration information to join the relay node group.

In accordance with yet another embodiment there is provided an apparatus comprising at least one processor and at least one memory including computer program code, the at least one memory and computer program code configured to with the at least one processor cause the apparatus at least to receive from a relay node information associated with the relay node group determined by the relay node; determine configuration information of the relay node for configuring the relay node to join the relay node group based on the received information; and send the configuration information to the relay node.

In another embodiment there is provided a computer program product comprising program code means which when loaded into a processor controls the processor to: send to a network access node determined information associated with the relay node group; receive from the network access node configuration information associated with the relay node group, the configuration information being determined based on the determined information associated with the relay node group; and distribute the configuration information for configuring one or more relay nodes of the relay node group to communicate with the network access node to one or more relay nodes of the relay node group.

In a further embodiment there is provided a computer program product comprising program code means which when loaded into a processor controls the processor to: receive determined information associated with the relay node group from a relay node; determine configuration information associated with the relay node group for configuring one or more relay nodes of the relay node group to communicate with a network access node based on the determined information associated with the relay node group; and send the configuration information to the relay node for distribution to the one or more relay nodes of the relay node group.

In another embodiment there is provided a computer program product comprising program code means which when loaded into a processor controls the processor to: send to a network access node information associated with the relay node group determined by a relay node; receive from the network access node configuration information associated with the relay node group, the configuration information being determined based on the information associated with the relay node group; and configure the relay node on the basis of the received configuration information to join the relay node group.

In a further embodiment there is provided a computer program product comprising program code means which when loaded into a processor controls the processor to: receive from a relay node information associated with the relay node group determined by the relay node; determine configuration information of the relay node for configuring the relay node to join the relay node group based on the received information; and send the configuration information to the relay node.

Various other aspects and further embodiments are also described in the following detailed description and in the attached claims.

The invention will now be described in further detail, by way of example only, with reference to the following examples and accompanying drawings, in which:

FIG. 1 shows a schematic diagram of a network according to some embodiments;

FIG. 2 shows another schematic diagram of a network access and relay nodes according to some embodiments;

FIG. 3 shows a schematic diagram of a control apparatus according to some embodiments;

FIG. 4 shows a flow diagram according to some embodiments;

FIG. 5 shows another flow diagram according to some embodiments;

FIG. 6 shows a signalling diagram according to some embodiments; and

FIG. 7 shows a signalling diagram according to some embodiments.

In the following certain exemplifying embodiments are explained with reference to wireless or mobile communication systems serving mobile communication devices. Before explaining in detail the certain exemplifying embodiments, certain general principles of a wireless communication system and the nodes thereof are briefly explained with reference to FIGS. 1 to 3 to assist in understanding of the herein described embodiments.

In a communication system 10 a user can be provided with a mobile communication device 1 that can be used for accessing various services and/or applications. The access can be provided via an access interface between the mobile user device 1 and an appropriate wireless access system of a communication system 10 comprising an access node. An access node can be provided by a base station. FIG. 1 shows part of a radio access network (RAN), including a base station 2. The term base station will be used in the following and is intended to include the use of any of these network access nodes or any other suitable access node. The communication system 10 also comprises a mobility management entity (not shown). The mobile management entity and the base station node 2 can be connected, for example, by means of a S1 interface.

An appropriate mobile user device or station may be provided by any device capable of sending and receiving radio signals. Non-limiting examples include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A mobile communication device is often called a user equipment (UE). Each mobile device 1 and base station 2 may have one or more radio channels open at the same time and may receive signals from more than one source.

FIG. 1 shows a base station 2 having a cell area associated therewith and the base station 2 is connected to relay nodes 3, 4, 5. In the cell area of the base station 2, there can be provided three relay nodes 3, 4 and 5, but it is noted that this is by way of example only. In practice there may be more or less than three relay nodes. In relaying a relay node (RN) is wirelessly connected to the radio-access network via a donor cell, that is the cell of base station 2 of FIG. 1.

The basic principle of relaying is shown in FIG. 2. Relay nodes may be used, for example, in block of flats and other buildings, offices, warehouses and/or factories and/or in public places, for example in shopping malls, sports or exhibition halls or arenas, particular areas of cities, on moving platforms such as trains, ships, aeroplanes and so on. FIG. 2 shows communication interfaces in a relay arrangement. The wireless interface 21 between user equipment 1 and a relay node 4 and/or 5 can be provided, for example, by an Uu interface. The wireless interface 6 between the relay node 3 and the donor base station 2 can be provided by an Un interface. The link 22 between a relay node and donor base station is often called a backhaul link.

Each of the relay nodes has a coverage area associated therewith. The coverage area may be smaller than the cell of the base station 2, of a similar size to the cell or larger than the cell. For the purposes of clarity the coverage area of each of the relay nodes 3, 4, 5 has not been shown. A relay link known as backhaul can be provided between each relay node and the base station. The user equipment 1 in the cell is able to communicate directly with the base station 2 or with the base station via a respective relay node depending on the location of the user equipment 1. In particular, if the user equipment 1 is in the coverage area associated with a relay node 3, 4, 5, the user equipment may communicate with the relay node(s) 3, 4, 5.

By way of example only, it is noted that the relay nodes 3, 4, 5 can in certain applications have lower transmission power compared to base station 2. The base station 2 can be, for example, a macro NodeB or an enhanced NodeB (eNB). The relay nodes can comprise cheaper radio frequency (RF) components such as oscillators and filters, due to relaxed requirements in standards. For example, the transmission power of a relay node can be about 100 times lower compared to the transmission power of an eNB and frequency stability requirements can be between the requirements of an eNB and a user equipment. The transmission and reception range for the relay nodes 3, 4, 5 may be adapted to small range scenarios.

The relay nodes 3, 4, 5, can be relatively low power nodes that may be deployed to provide enhanced indoor coverage, additional capacity at hotspots or cell edge regions. For example, in the case of indoor deployment, such an access point or node may be provided for example in apartment blocks or office buildings and hence there may be a relatively high density of such access nodes.

Returning to FIG. 1, there is shown a gateway function 9 of the communication system 10 connecting a core network 11 and/or another network, application functions or services 12. A packet data network may also be provided by means of appropriate gateway nodes. Regardless of the gateway arrangement, a communication device 1 can be connected to an external data network, for example the internet via the relay nodes 3, 4, 5 and/or the base station 2.

The base station 2 can be typically controlled by at least one appropriate controller apparatus 6. The relay nodes 3, 4, 5 are also typically controlled by at least one appropriate controller apparatus 13, 14, 15. FIG. 3 shows an example for a controller apparatus for a relay node 3, 4, 5 or a base station 2. The controller apparatus 6 is typically provided with at least one memory 31, at least one data processor 32 and an input/output interface 34 as shown in FIG. 3. The control apparatus 6 of the base station 2 or the relay nodes 3, 4, 5 can further comprise a mobility management block 33. The control apparatus 6 can be configured to execute appropriate software applications to provide the desired control functions. The control apparatus 6, when provided in a node and comprising at least one memory and computer program code can be configured, with the at least one processor, to cause a relay node of a group of relay nodes to communicate with the access system of the communication system 10 on the behalf of another relay node of the group serving the mobile device and/or to communicate control information with other relay nodes in the group and/or maintain information about active mobile devices in the group, as will be explained in more detail below. At least some of the processing of the processing blocks may be carried out by one or more processors in conjunction with one or more memories. The processing block may be provided by an integrated circuit or a chip set. The control entity can be interconnected with other control entities.

The mobile communication devices 1 can access the communication system 10 based on various access techniques, such as code division multiple access (CDMA), or wideband CDMA (WCDMA), the latter technique being used by some communication systems based on the third Generation Partnership Project (3GPP) specifications. For LTE and LTE-A, OFDMA (Orthogonal Frequency Division Multiplexing) in the DL (down link) and single-carrier FDMA in the UL (uplink) can be used. Other examples include time division multiple access (TDMA), frequency division multiple access (FDMA), space division multiple access (SDMA) and so on. In a wireless system a network entity such as a base station provides an access node for communication devices 1.

A non-limiting example of mobile architectures where the herein described principles may be applied is known as the Evolved Universal Terrestrial Radio Access Network (E-UTRAN). Non-limiting examples of appropriate access nodes are a base station of such system, for example what is known as NodeB (NB) or eNB in the vocabulary of the 3GPP specifications. Other examples include base stations of systems that are based on technologies such as wireless local area network (WLAN) and/or WiMax (Worldwide Interoperability for Microwave Access). Access nodes can provide cellular system level base stations providing E-UTRAN features such as user plane Radio Link Control/Medium Access Control/Physical layer protocol (RLC/MAC/PHY) and control plane Radio Resource Control (RRC) protocol terminations towards mobile communication devices.

The relay nodes (RN) 3, 4, 5 of FIG. 1 can form a portion or all of a relay system based on a relay node group 20 such as a co-operative cell group (CCG). The co-operative cell group is arranged to be connected and relayed to a donor base station (DeNB), for example base station 2. The co-operative relay system is a smart cooperative relay system that is based on the notion of having a close group of relay nodes, often deployed together for a particular common service area or space such as an indoor office (fixed relays) or a passenger train (moving relays). The relay nodes of the CCG are interconnected and wireless links can be provided between the base station 2 and one or more of the relay nodes 3, 4 and 5.

The relay nodes 3, 4, 5 may be inter-connected with a relay node to relay node (RN-RN) cooperative interface. This interface may be realized using either a wire-line interface (for example such as the X2 interface or a similar interface) or a wireless interface. The wireless interface can be arranged to operate on a different spectrum band than that of the donor cellular system (out of band) to avoid interference. A part of the relay node to relay node (RN-RN) link can be used for the normal cooperative functions such as cooperative multiple input multiple output (MIMO), network coding, and so on. The link can also be used to other purposes such as load balancing, signalling cell changes, notifications, warnings, and so on.

A principle of the co-operative relays is to explore and utilize different diversities such as notable time-space and user diversities associated with the close cooperative group of relay nodes or cooperative cell group. The close group can be employed in different deployment scenarios in order to improve radio resource utilization on the wireless backhaul for better or more optimized network operation and performance. A relay node 3 connected to the donor base station 2 can act as anchor point. In some embodiments opaque mobility management can be used for optimizing inter-relay node handover, which is hidden to the donor cellular system, for example DeNB 2.

In the relay node group 20 shown in FIGS. 1 and 2, a first relay node 3 is connected to a second relay node 4. The second relay node 4 has a connection with the mobile device 1. Should a need for handover arise, the mobile device 1 can be handed over to a third relay node 5. The first relay node 3 and the third relay node 5 can then be in direct communication over a RN-RN link. Alternatively, the first relay node 3 may be connected to the third relay node 5 via the second relay node 4 over two RN-RN links. A cooperative-relay interface between the relay nodes 3, 4, 5 inside the relay node group can be used to enable further enhancement and optimization for the connection mobility management of active user equipments moving inside a relay node group coverage area. The mobility management can include inter-cell handover (HO) procedure between neighboring relay node cells of the co-operative cell group. A non-limiting example of the interface that can be used for this purpose and other communication is a Cooperative Relay X2 interface (crX2) between the relay nodes.

In the relay node group 20 the interconnected relay nodes 3, 4, 5 can share relay-link or wireless backhaul capacity in an efficient, coordinated and controlled manner. The relay nodes 3, 4, 5 can be connected and relayed to the same or different neighboring donor base station. Such an arrangement may be used for example where a plurality of relay nodes is provided to enhance cellular coverage and/or in embodiments that relate to relay-enhanced cellular networks, for example 3GPP LTE-A Release 10 and beyond enabled systems.

The relay nodes 3, 4, 5 in some embodiments can be configured on start up or during operation. Previous proposals have suggested to configure relay nodes accessing a donor cellular system individually. This means that a significant delay is require before an entire relay node group can access the donor cellular system. Furthermore, since each relay performs configuration with the base station of the donor cellular system individually, significant radio resources are used.

Some detailed embodiments will now be described in reference to FIG. 4 and FIG. 6. FIG. 4 shows a flow diagram of a method performed by a relay node according to some embodiments. FIG. 6 shows a signalling diagram of various elements of a predefined relay node group and a communication system. The predefined relay node group 20 can be a static relay node group and can be formed before activation or deployment of the relay nodes 3, 4, and 5 in a particular area. In some embodiments, the relay node group 20 may be installed in a passenger train. For example, each carriage of the passenger train can have one or more relay nodes installed therein. In this way, the relay nodes 3, 4, 5 can be arranged in a predetermined relay node group by virtue of the arrangement of the carriages of the passenger train. Of course, the relay nodes can be used for other places such as buildings, ships, aircraft or any other suitable area requiring relay node services.

One or more relay nodes 3, 4, 5 can power on as shown in block 602 of FIG. 6. After the relay nodes 3, 4, 5 have activated, the control apparatuses of the relay nodes 3, 4, 5 can perform an inter-connection procedure for establishing the predetermined relay node group 20 as shown in arrow 604. The relay nodes 3, 4, 5 communicate with each over any suitable interface such as one or more crX2 interfaces. In other embodiments, the relay nodes can communicate with each other wirelessly. The processor 32 of one or more relay nodes 3, 4, 5 are configured to establish the relay node group according to predetermined information. The predetermined information can be stored in memory 31 of the control apparatus 13, 14, 15 of the relay nodes 3, 4, 5.

Once the relay nodes have been activated and established inter-connections, the relay nodes 3, 4, 5 can be organised in to one or more sub-groups. Indeed, the relay node group 20 can be divided in to sub-groups on the basis of one or more factors. For example, the relay nodes can be separated in to different sub-groups according to different cellular operators. Additionally or alternatively, the relay nodes can be separated into sub-groups on the basis of the location of the relay node. For example, a sub-group can be provided for first class carriages only and another sub-group can be provided for second class carriages only. In some embodiments the relay nodes of one or more sub-groups of the relay node group can be activated, leaving other relay nodes switched off. In fact, the relay node group 20 can be divided into sub-groups according to any suitable factor.

Once the predetermined relay group 20 has been established, the relay nodes 3, 4, 5 determine information associated with the relay node group 20 as shown in step 606. In some embodiments determining information of the relay node group 20 comprises sending and receiving information from some or all of the relay nodes. The determined information can comprise control information of the relay node group 20. The relay nodes 3, 4, 5 can further transmit and distribute control information to each other over the crX2 interfaces.

The information associated with the relay node group can comprise one or more of the following: the number of activated relay nodes in the relay node group, the network topology of the activated relay nodes. The information can also comprise an indication of whether only a part of the predetermined relay node group has been activated. For example, the information can comprise an indication of whether a sub-group of the predetermined relay node group can be initiated first and whether one or more inactive relay nodes can be activated at a later point. The information can also comprise an indication of when the inactive relay nodes will be activated. For example, the information can indicate that a passenger train may have ten carriages, each with a relay node of the relay node group, but only the relay nodes in the first five carriages are activated initially and the rest of the relay nodes can be activated at a later point.

The first relay 3 is then selected to communicate with the donor cellular network as shown in step 608. The processor 32 of the first relay 3 selects the first relay 3 as the only relay of the relay node group 20 to communicate with the DeNB 2. This means that all of the relay nodes are prevented from communicating with the DeNB 2 at the same time, which preserves radio resources and avoids congestion. The first relay 3 can be selected by the processor 32 on the basis of network topology, such as the relay node with the most number of connections to other relay nodes in the relay group. Alternatively or additionally the first relay node 3 can be selected by the processor 32 on the basis of the relay node with the fewest number of hops to communicate with all the relay nodes in the relay group. Alternatively the first relay node 3 can be selected randomly by the processor 32. Alternatively, in some embodiments, the first relay 3 is preselected and an indication of the preselected relay node is stored in memory 31 of the control apparatus 13, 14, 15 of one or more of the relay nodes 3, 4, 5. This may be permitted if the geographic structure and interconnection set-up of the network is predetermined. In some embodiments, if the relay node group 20 comprises a plurality of sub-groups, a relay node in each sub-group can be selected to communicate with the DeNB 2. Furthermore, the relay node group and sub-groups thereof may communicate with more than one DeNBs of the same or different operators' networks.

The first relay node 3 then performs the relay node startup procedure according to 3GPP release 10 specified for relay nodes attaching to the donor cellular system via the DeNB 2 as shown in step 610. Initially the first relay node 3 attaches to the donor cellular network via a legacy user equipment procedure to authenticate the user equipment function of the first relay node 3 and to establish basic connectivity.

The processor 32 of the relay node 3 then sends information associated with the first relay node 3 as well as the relay node group information determined when establishing the relay node group 20 as shown in step 611 and step 402 of FIG. 4.

The DeNB 2 receives the determined relay node group information and sends the information for authentication by the donor cellular network. In some embodiments the DeNB 2 sends the information to a network element 600 in the evolved packet core (EPC) to authenticate the eNB functionality of the relay nodes as shown in block 612. In some embodiments the network element 600 for authenticating the relay nodes can be an operation and maintenance (O&M) system 600. Alternatively, the network element 600 can be any suitable means for authenticating and determining configuration information of the relay nodes 3, 4, 5. Indeed, the DeNB and MME can authenticate the relay nodes and/or determine the configuration information in some embodiments. In this way, all the activated relay nodes 3, 4, 5 can be authenticated by the donor cellular system on the basis of the determined information sent by the first relay node 3. The network element 600 authenticates the relay nodes 3, 4, 5 based on stored subscription information associated with the relay nodes 3, 4, 5 and the determined relay node group information.

In some embodiments, subscription information associated with the relay node group 20 can be stored within the donor cellular system. For example, the DeNB 2 and MME, or another network element 600 in the evolved packet core (EPC) can store the information associated with the relay node group 20. The stored subscription information associated with the relay node group 20 can be linked to configuration information necessary to configure one or more relay nodes 3, 4, 5 after activation to operate as a cooperative close group and/or access the donor cellular system. In some embodiments, the stored subscription information associated with the relay node group 20 can be one or more of the following: relay node group identifier, the maximum number of relay nodes in the relay node group 20, each individual relay node identifier and network topology of the relay node group.

Once the relay nodes 3, 4, 5 have been authenticated, the network element 600 determines configuration information for the relay node group 20 as shown in block 614. The network element 600 can determine the configuration information on the basis of the relay node group information received from the first relay node 3. For example, the network element 600 can determine the configuration information, linked to relay node subscription information, for the relay node group 20 on the basis of the relay node group identifier. The relay node group identifier is comprised in the determined information received from the first relay node 3. In some embodiments the configuration information associated with the relay node group can be any information suitable for configuring one or more relay nodes to communicate with the DeNB 2.

The network element 600 then sends the determined configuration information to the first relay node 3 via the DeNB 2 as shown in step 616. The configuration information can be for all the relay nodes in the relay node group or just for the activated relay nodes. The DeNB 2 transmits the configuration information via the previously established radio resource control (RRC) connection between the first relay node 3 and the DeNB 2.

The first relay node 3 receives the configuration information from the network access node or DeNB 2 as shown in step 404 of FIG. 4. In response to receiving the configuration information, the first relay node 3 distributes the configuration information to one or more active relay nodes of the relay node group 20 as shown in step 618 or step 406 of FIG. 4. In some embodiments the processor 32 of the first relay node 3 initiates distributing the configuration information to the other relay nodes 4, 5 by means of the crX2 connection.

In this way, there are no unnecessary duplicate information exchanges between the donor cellular network and the relay nodes of the relay node group 20. This means that the processing capacity of the donor cellular network and the radio resource usage is reduced.

The other relay nodes 4, 5 in the relay node group 20 upon getting the configuration information and configuring their settings in accordance therewith, can communication with the DeNB 2 as shown in step 620. Since the network element 600 has previously authenticated the other relay nodes 4, 5, the

DeNB 2 can activate the configuration of the relay nodes 4, 5 immediately, without further consultation with the donor cellular network as shown in step 622. Thereafter the other relay nodes 4, 5 operate in a normal mode as shown in step 624 and no further startup procedures for the other relay nodes 4, 5 are required. This procedure allows for a faster and more efficient relay node configuration during start up of a relay node group.

In some embodiments one or more inactive relay nodes can be activated after the relay node group 20 has been established and operating in a normal mode. When the inactive relay nodes power on, one or more relay nodes 3, 4, 5 can send the configuration information to the recently powered on relay nodes. In some embodiments the configuration information can have been previously determined for the subsequently powered on relay nodes in step 614. In this way the recently powered on relay nodes can immediately be configured to access the donor cellular network via the DeNB 2.

Alternatively, one or more of the relay nodes 3, 4, 5 can determine information associated with the recently powered on relay nodes and the determined information can be sent to the network element 600 as previously discussed in step 611. In this way, steps 612, 614, 616, 618 can be carried out for determining and distributing configuration information for the recently activated relay nodes. Furthermore in some embodiments, the configuration information can comprise reconfiguration information for reconfiguring the relay node group in light of the recently activated relay nodes.

In some embodiments the relay node group is controlled by a first operator. The relay node group 20 in some embodiments can operate with multiple cellular operators. That is the relay node group can establish connections with a plurality of different donor cellular systems at the same time. For example passengers on a train may have user equipment operable on different cellular networks. In this way, the relay node group 20 may be required to connect to each cellular network as required by the user equipment 1 in the relay node group service area. In some embodiments the processor 32 can perform the method as described in FIGS. 4 and 6 for each donor cellular network. This means that the relay nodes 4,5 can receive configuration information from a plurality of different donor cellular networks. In some embodiments different relay nodes of the relay node group 20 can be arranged to perform the configuration methods for different donor cellular systems. In this way, configuration methods for access multiple donor cellular system can be carried out at the same time.

Furthermore, in some embodiments some of the relays nodes of a relay node group can be dedicated to a single donor cellular system. Alternatively, all the relay nodes can be arranged to access each of the available different donor cellular systems.

In some embodiments the configuration information received from the donor cellular system and distributed to the other relay nodes 4, 5 can comprises configuration information for limited initial access to the donor cellular system. For example, the configuration information can comprise information to gain quick radio access to the DeNB 2 via a dedicated random access channel (RACH) resource. The configuration information can comprise one or more of the following: transmit power and timing advance information for non-contention based random access procedure to the DeNB 2. The other relay nodes 4, 5 can then communicate with the DeNB 2 to initiate their own radio resource control (RRC) connection.

Some further detailed embodiments will now be described in reference to FIG. 5 and FIG. 7. FIG. 5 shows a flow diagram of a method performed by a relay node according to some embodiments. FIG. 7 shows a signalling diagram of various elements of a dynamic relay node group and a communication system.

FIG. 7 shows the signalling diagram of an active relay node group 20 having relay nodes 3, 4, 5 operating in a normal mode. Indeed, the relay nodes 3, 4, 5 may have been established accordingly to the embodiments described in reference to FIGS. 4 and 6.

In contrast to the embodiments discussed in reference to FIGS. 4 and 6, the relay node group may be formed dynamically under the control of the donor cellular network. In this way, the relay node group 20 may not be previously determined. Alternatively, a portion of the relay node group 20 may be predetermined, but the donor cellular network may control modifications to the relay node group 20 after the relay node group has been established.

A new relay node 700 may power on as shown in block 702. Once the new relay node 700 has activated, the new relay node 700 accesses the donor cellular network via DeNB 2 according to known connection cellular procedures as shown in step 704.

During the connection process, the processor 32 of the control apparatus 6 of the DeNB initiates the new relay node 700 to join the existing relay node group 20.

The new relay node 700 receives a request to determine relay node group information of the relay node group 20 as shown in block 706. In particular, the new relay node 700 can determine measurements of one or more of the relay nodes of the existing relay group 20. For example the new relay node 700 can determine the relay node identifier of one or more relay nodes 3, 4, 5 in the relay node group 20 or the relay node group identifier. The new relay node 700 sends the relay node group information to the network access node 2, as shown in step 502 of FIGS. 5 and 708 of FIG. 7. Alternatively the relay node can determine relay node group information and then establish a connection combining steps 704 and 708.

The processor 32 of the DeNB 2 then initiates determining the configuration information of the new relay node 700 based on the received determined relay node group information from the new relay node 700 as shown in block 710. In some embodiments the DeNB sends the determined relay node group information to a network node 600 for determining the configuration information 600. The network node 600 can determine the configuration information based on subscription information linked to the relay node group identifier. In other embodiments, the DeNB 2 is arranged to determine the configuration information within the control apparatus 6 of the DeNB. In some embodiments, the configuration information can be determined based additionally or alternatively on one or more of the following: relay node capability, measurement reports of the radio environment, relay node physical location, relay node group structure and topology and other suitable information. The processor 32 of the DeNB 2 then sends the configuration information to the new relay node 700. The configuration information comprises configuration information for the new relay node 700 to join the existing relay node group 20.

In some embodiments the configuration information comprises one or more of the following: the relay node group identifier, the identifier of the individual relay nodes in the group, the crX2 interface configuration and any other suitable configuration information.

The new relay node 700 receives the configuration information as shown in steps 712 and 404. The new relay node can then be configured in accordance with the configuration information such that the new relay node can join the relay node group 20 as shown in steps 714 and 406.

In some embodiments, the configuration information optionally comprises configuration information for both the new relay node 700 and the relay nodes of the relay node group. In this way the relay node group can be reconfigured to accommodate the new relay node. The new relay node 700 distributes the new configuration information after joining the relay node group 20 as shown step 716.

In a further embodiment, the DeNB 2 can signal one or more of the relay nodes 3, 4, 5 of the relay node group during normal operation to reconfigure the relay node group. In response to receiving reconfiguration information, the one or more relay nodes of the relay group can distribute the configuration information to the rest of the relay nodes to update the relay node group configuration accordingly. For example, the relay node group can be reconfigured to add more relay nodes and to connect the relay node group to a different donor cell of same operator or a different operator in order to increase the backhaul link capacity.

It is noted that whilst embodiments have been described in relation to LTE-Advanced, similar principles can be applied to any other communication system. Also, instead of carriers provided by a base station a carrier comprising component carriers may be provided by a communication device such as a mobile user equipment. For example, this may be the case in application where no fixed equipment provided but a communication system is provided by means of a plurality of user equipment, for example in adhoc networks. Therefore, although certain embodiments were described above by way of example with reference to certain exemplifying architectures for wireless networks, technologies and standards, embodiments may be applied to any other suitable forms of communication systems than those illustrated and described herein.

It is also noted herein that while the above describes exemplifying embodiments of the invention, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed, there is a further embodiment comprising a combination of one or more of any of the other embodiments previously discussed.

1. A method of configuring a relay node group comprising:
sending to a network access node determined information associated with the relay node group;
receiving from the network access node configuration information associated with the relay node group, the configuration information being determined based on the determined information associated with the relay node group; and
distributing the configuration information for configuring one or more relay nodes of the relay node group to communicate with the network access node to one or more relay nodes of the relay node group.

2. A method according to claim 1 wherein the method comprises determining information associated with the relay node group from one or more relay nodes after the one or more relay nodes are activated and connections between the one or more relay nodes of the relay node group are established.

3. A method according to claim 1 wherein the method comprises selecting a relay node to communicate with the network access node and to send the determined information associated with the relay node group.

4. A method according to claim 3 wherein the selected relay node is selected on the basis of a random selection or on the basis of the relay node with the most direct connections to other relay nodes in the relay node group.

5. A method according to claim 1 wherein the configuration information is determined based on predetermined relay node group subscription information.

6. A method according to claim 5 wherein the predetermined relay node group subscription information is one or more of the following: relay node group identifier, maximum number of relay nodes in the relay node group, one or more relay node identifiers, and network topology.

7.-8. (canceled)

9. A method according to claim 1 wherein the determined information associated with the relay node group comprises one or more of the following: the number of activated relay nodes in the relay node group and the network topology.

10. A method according to claim 1 wherein the method comprises activating other relay nodes of the relay node group after the one or more relay nodes have been configured with the configuration information.

11.-12. (canceled)

13. A method of configuring a relay node group comprising:
receiving determined information associated with the relay node group from a relay node;
determining configuration information associated with the relay node group for configuring one or more relay nodes of the relay node group to communicate with a network access node based on the determined information associated with the relay node group; and
sending the configuration information to the relay node for distribution to the one or more relay nodes of the relay node group.

14. A method according to claim 13 wherein the method comprises authenticating the one or more relay nodes for communication with the network access node on the basis of the determined information associated with the relay node group.

15. A method according to claim 13 wherein the determining the configuration information comprises comparing predetermined relay node group subscription information with the determined information associated with the relay node group.

16. A method according to claim 15 wherein the predetermined relay node group subscription information is received from one or more relay nodes of the relay node group.

17. A method according to claims 13 wherein the sending the configuration information comprises sending reconfiguration information for reconfiguring one or more relay nodes of the relay node group in response to a change to the relay node group.

18. A method of configuring a relay node group comprising:
sending to a network access node information associated with the relay node group determined by a relay node;
receiving from the network access node configuration information associated with the relay node group, the configuration information being determined based on the information associated with the relay node group; and
configuring the relay node on the basis of the received configuration information to join the relay node group.

19. A method according to claim 18 wherein the method comprises determining information associated with the relay node group.

20. A method according to claim 19 wherein the determined information comprises detected physical cell identification information.

21. A method of configuring a relay node group comprising:
receiving from a relay node information associated with the relay node group determined by the relay node;
determining configuration information of the relay node for configuring the relay node to join the relay node group based on the received information; and
sending the configuration information to the relay node.

22. A method according to claim 18 wherein the method comprises sending reconfiguration information to one or more relay nodes of the relay node group for reconfiguring the relay node group in response to the relay node joining the relay node group.

23.-44. (canceled)

45. An apparatus comprising:
at least one processor and at least one memory including computer program code, the at least one memory and computer program code configured to with the at least one processor cause the apparatus at least to:
send to a network access node determined information associated with the relay node group;
receive from the network access node configuration information associated with the relay node group, the configuration information being determined based on the determined information associated with the relay node group; and
distribute the configuration information for configuring one or more relay nodes of the relay node group to communicate with the network access node to one or more relay nodes of the relay node group.

46. An apparatus comprising:
at least one processor and at least one memory including computer program code, the at least one memory and computer program code configured to with the at least one processor cause the apparatus at least to:
receive determined information associated with the relay node group from a relay node;
determine configuration information associated with the relay node group for configuring one or more relay nodes of the relay node group to communicate with a network access node based on the determined information associated with the relay node group; and
send the configuration information to the relay node for distribution to the one or more relay nodes of the relay node group.

47. An apparatus comprising:
at least one processor and at least one memory including computer program code, the at least one memory and computer program code configured to with the at least one processor cause the apparatus at least to:
send to a network access node information associated with the relay node group determined by a relay node;
receive from the network access node configuration information associated with the relay node group, the configuration information being determined based on the information associated with the relay node group; and
configure the relay node on the basis of the received configuration information to join the relay node group.

48. An apparatus comprising:
at least one processor and at least one memory including computer program code, the at least one memory and computer program code configured to with the at least one processor cause the apparatus at least to:
receive from a relay node information associated with the relay node group determined by the relay node;
determine configuration information of the relay node for configuring the relay node to join the relay node group based on the received information; and
send the configuration information to the relay node.
